(19) United States
(12) Patent Application Publication
(10) Pub. No.: US 2018/0334607 A1
(43) Pub. Date: Nov. 22, 2018

(54) Multi-Trigger Systems for Controlling the Degradation of Degradable Materials

(71) Applicant: DropWise Technologies Corp., Cambridge, MA (US)

(72) Inventors: Adam T. Paxson, Cambridge, MA (US); Hyukmin Kwon, Boston, MA (US); David C. Borrelli, Cambridge, MA (US); Christy D. Petruczok, Somerville, MA (US); Benny Chen, Medford, MA (US)

(21) Appl. No.: 15/976,183

(22) Filed: May 10, 2018

Related U.S. Application Data
(60) Provisional application No. 62/508,685, filed on May 19, 2017.

(51) Int. Cl. C09K 8/42; C09K 8/44; C09K 8/516; E21B 29/02

(52) U.S. Cl. CPC C09K 8/426; C09K 8/44; E21B 43/26; E21B 29/02; C09K 8/516

(57) ABSTRACT

A downhole tool has a substrate including a degradable material, a protective barrier configured to protect the degradable material from a downhole environment, and a first trigger comprising a first trigger material that delaminates after contact with an organic solvent.

### PRIORITY

This patent application claims priority from provisional U.S. patent application No. 62/508,685, filed May 19, 2017, entitled, “Multi-Trigger Systems for Controlling the Degradation of Degradable Materials,” attorney docket number 4221/102, and naming David C. Borrelli, Adam T. Paxson, Hyukmin Kwon, Christy D. Petruczok, and Benny Chenas inventors, the disclosure of which is incorporated herein, in its entirety, by reference.

### FIELD OF THE INVENTION

The present application relates to degradable downhole tools for oil and gas drilling, well completion, and production applications, and more particularly to trigger systems for timing and controlling their degradation.

### BACKGROUND OF THE INVENTION

Degradable materials are of great benefit for a range of applications. These materials can be subjected to harsh and challenging environments, including high salt concentrations, high or low pH, high temperatures, and high pressures.

### SUMMARY OF VARIOUS EMBODIMENTS

In accordance with one embodiment of the invention, a downhole tool includes: a substrate including a degradable material, a protective barrier configured to protect the degradable material from a downhole environment, and a first trigger comprising a first trigger material that delaminates after contact with an organic solvent.

In addition, or alternatively, the first trigger may undergo swelling, gelling, softening, dissolution, etching, reacting, shrinking, cracking, crazing, shape change, or permeability change after contact with the organic solvent. The first trigger may activate within about 1 minute to 60 minutes of contact with the organic solvent, and/or may expose the substrate to one or more components of the downhole environment. The first trigger also may cover a breach in the protective barrier.

Among others, the first trigger material may exhibit a swelling percentage of at least 2.5% after contact with the prescribed organic solvent, where the swelling is by weight, volume, or both. The first trigger material may be a polymer selected from the group consisting of polyurethanes, polysiloxanes, polyacrylates, polyepoxides, waxes, and combinations thereof. The organic solvent may be selected from the group consisting of ketones, alcohols, ethers, hydrocarbons, and combinations thereof. The organic solvent also may be selected from the group consisting of acetone, methanol, ethanol, propanol, isopropanol, benzene, ethylbenzene, toluene, xylene, gasoline, diesel fuel, biodiesel fuel, kerosene, tetrahydrofuran, oil-based mud, and combinations thereof.

The barrier may comprise a conformal coating deposited on the substrate with chemical vapor deposition. The downhole tool may further comprise a second trigger configured to activate within about 60 minutes to 16 hours of contact with an aqueous fluid. The second trigger may comprise a second trigger material that degrades on contact with the aqueous fluid. Among other things, the second trigger material may comprise a chemical element selected from the group consisting of magnesium, aluminum, calcium, germanium, zinc, manganese, and combinations thereof. The aqueous fluid may be selected from the group consisting of a salt solution, an acidic solution, an alkali solution, and combinations thereof. A ratio Y/X may be from about 2 to about 100,000, Y being a time of activation of the second trigger, X being a time of activation of the first trigger. The downhole tool may be selected from the group consisting of a frack plug, frack ball, oilfield services element, oilfield element, collar, packer, sleeve, tubing, anchor, flow pipe, sensor, lock, actuator, cable, seal, projectile, liner, pump, motor, drilling equipment, mandrel, joint, centralizer, ball drop system, shroud, sand screen, casing, or sheet.

In another embodiment, a method treats a downhole formation by positioning a frack plug in a wellbore. This frack plug includes a substrate with a degradable material, a protective barrier configured to protect the degradable material from a downhole environment, a first trigger comprising a first trigger material that delaminates after contact with an organic solvent, and a second trigger configured to activate after contact with an aqueous fluid. The method exposes the plug to a wellbore fluid comprising an aqueous fluid.

The aqueous fluid may be brine. The method may further expose the plug to an organic solvent, which may be selected from the group consisting of ketones, alcohols, ethers, hydrocarbons, and combinations thereof. The organic solvent also may be selected from the group consisting of acetone, methanol, ethanol, propanol, isopropanol, benzene, ethylbenzene, toluene, xylene, gasoline, diesel fuel, biodiesel fuel, kerosene, tetrahydrofuran, oil-based mud, and combinations thereof. The method may further expose the plug to an aqueous fluid after exposing the plug to the organic solvent. The aqueous fluid may be selected from the group consisting of a salt solution, an acidic solution, an alkali solution, and combinations thereof. The first trigger may activate within about 60 seconds to about 60 minutes of contact with the organic solvent. Moreover, the first trigger material may exhibit a swelling percentage of at least 2.5% after contact with an organic solvent, where the swelling is by weight, volume, or both. The first trigger material may be a polymer selected from the group consisting of polyurethanes, polysiloxanes, polyacrylates, polyepoxides, waxes, and combinations thereof. The substrate may be substantially dissolved within about 1 hour to seven days of subsequent exposure to the aqueous fluid. The method may further place an explosive charge up-hole of the plug and setting off the explosive charge.

In some embodiments, the method may further hydraulically frack up-hole of the plug. The second trigger may comprise a second trigger material which degrades on contact with an aqueous fluid and be formed from a second trigger material of a chemical element selected from the group consisting of magnesium, aluminum, calcium, germanium, zinc, manganese, and combinations thereof. A ratio Y/X may be from about 2 to about 100,000, where Y is a time of activation of the second trigger, and X is a time of activation of the first trigger. The downhole formation may contain at least one of natural gas and petroleum.

In accordance with other embodiments, a downhole tool has a substrate including a degradable material, a protective barrier configured to protect the degradable material from a downhole environment, and a first trigger comprising a polymer that, after exposure to a prescribed organic solvent for between about 1 minute and about 90 minutes, exposes the substrate to at least one component of the downhole environment. The first trigger may activate within 30 minutes of contact with the organic solvent and/or the polymer may exhibit a swelling percentage of at least 2.5% after contact with the organic solvent, where the swelling by weight, volume, or both.

The polymer may be selected from the group consisting of polyurethanes, polysiloxanes, polyacrylates, polyepoxides, waxes, and combinations thereof. The organic solvent may be selected from the group consisting of ketones, alcohols, ethers, hydrocarbons, and combinations thereof. The organic solvent also may be selected from the group consisting of acetone, methanol, ethanol, propanol, isopropanol, benzene, ethylbenzene, toluene, xylene, gasoline, diesel fuel, biodiesel fuel, kerosene, tetrahydrofuran, oil-based mud, and combinations thereof. The downhole tool may be selected from the group consisting of a frack plug, frack ball, oilfield services element, oilfield element, collar, packer, sleeve, tubing, anchor, flow pipe, sensor, lock, actuator, cable, seal, projectile, liner, pump, motor, drilling equipment, mandrel, joint, centralizer, ball drop system, shroud, sand screen, casing, or sheet. After exposure to the organic solvent, the degradation of the substrate may be activated within 30 minutes of subsequent exposure to brine. The downhole tool may further comprise a second trigger configured to activate after contact with an aqueous fluid.

In accordance with still other embodiments of the invention, a method of manufacturing a downhole tool applies a protective barrier to a substrate of a degradable material, and installs a first trigger comprising a first trigger material that exhibits a swelling percentage of at least 2.5% after contact with a prescribed organic solvent, where the swelling is by weight, volume, or both. Among other ways, the barrier may be applied with chemical vapor deposition. The method may install a second trigger that is configured to activate within about 60 minutes to 16 hours of contact with an aqueous fluid.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a schematic illustration of a downhole tool.

FIG. 2 is a schematic illustration of a downhole tool fitted with a slow-acting trigger.

FIG. 3 is a schematic illustration of a downhole tool fitted with a fast-acting trigger.

FIG. 4 is a schematic illustration of a downhole tool fitted with a slow-acting trigger and a fast-acting trigger.

FIG. 5 illustrates example timescales of two different triggers operating by two different mechanisms on a degradable material.

FIG. 6 illustrates an example method for manufacturing a downhole tool.

FIG. 7 illustrates an example method for using a degradable downhole plug.

FIG. 8 illustrates an exemplary test of partial delamination of an epoxy patch after being soaked in toluene for approximately one hour, and the degradation of the exposed area after soaking in brine.

FIG. 9 illustrates an exemplary test of complete delamination of a silicone patch after soaking in a hydrocarbon mixture for about 50 minutes, and the degradation of the exposed area in a 1-10 wt % KCl aqueous solution at a temperature of 150° F.

FIG. 10 illustrates an exemplary test of partial delamination of a urethane patch after soaking in xylene for approximately one hour, and the degradation of the exposed area after soaking in brine.

FIG. 11 illustrates exemplary tests on differently shaped silicone patches over a degradable alloy part. The degradation of the underlying material is shown in the second row of images which were taken after delamination of the silicone patches due to solvent exposure.

FIG. 12 illustrates an epoxy patch in cross shape groove partially delaminating after approximately one hour in warm xylene. The partially delaminated area turned black as it degraded when subsequently soaked in warm potassium chloride brine.

### DESCRIPTION OF ILLUSTRATIVE EMBODIMENTS

### Definitions

As used in this description and the accompanying claims, the following terms shall have the meanings indicated, unless the context otherwise requires:

The term “organic solvent” refers to a solvent containing carbon.

The term “polymer” refers to a molecule containing at least 10 repeats of a same subunit.

The term “hydrocarbon” refers to a compound consisting entirely of hydrogen and carbon. Aromatic hydrocarbons (arenes), alkanes, alkenes, cycloalkanes, and alkyne-based compounds are representative types of hydrocarbons.

The term “swelling percentage by weight” of a material that swells after exposure to a solvent refers to the quantity calculated according to the following formula:

Swelling (%)=(Ws−Wd)/Wd*100,

where Wd is the weight of the dry material and Ws is the weight of the swollen material.

The term “swelling percentage by volume” of a material that swells after exposure to a solvent refers to the quantity calculated according to the following formula:

Swelling (%)=(Vs−Vd)/Vd*100,

where Vd is the volume of the dry material and Vs is the volume of the swollen material. This corrects a typographical error of the provisional patent application to which this claims priority in which Vs was suggested as being the weight of the swollen material. Indeed, one skilled in the art would recognize that in this context, Vs is a volume and not a weight.

The term “wt %” means weight percent which is sometimes written as w/w.

Downhole Tools

A protective barrier, such as a coating, that encapsulates an underlying degradable material(s) can be used to control the exposure of the material to the wellbore environment. Additionally, optional trigger mechanisms can expose the degradable material to wellbore fluids at desired times and rates. Provided herein are barriers that are strong enough to protect degradable materials but are combined with triggers that activate degradation on command.

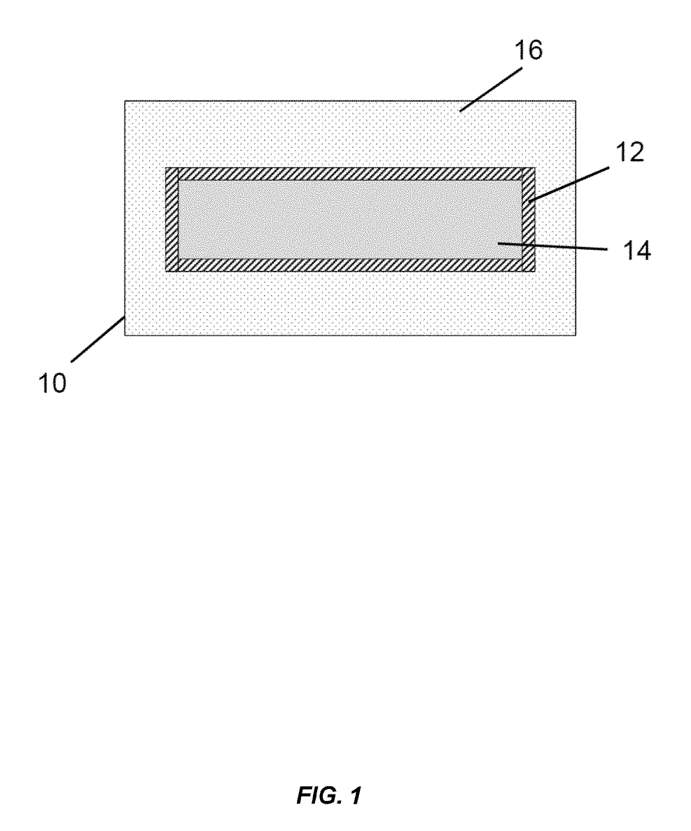

FIG. 1 is a schematic illustration of a downhole tool 10. The tool 10 includes a barrier 12 that protects a substrate 14 from surrounding environment 16, such as the downhole environment in a wellbore. The substrate 14 includes one or more degradable materials and may be homogeneous or heterogeneous. In some instances, the substrate 14 may also feature inclusions that are not degradable. The substrate 14 may be made from casting and have a certain degree of porosity, or it may be sintered. The downhole tool 10 may be, for example, a frack plug, frack ball, oilfield services element, oilfield element, collar, packer, sleeve, tubing, anchor, flow pipe, sensor, lock, actuator, cable, seal, projectile, liner, pump, motor, drilling equipment, mandrel, joint, centralizer, ball drop system, shroud, sand screen, casing, or sheet.

The Substrate

The degradable material (or materials) is designed to degrade, dissolve, disintegrate, or corrode upon exposure to the environment 16. The environment 16 is typically characterized by the features of the wellbore fluid(s) that the tool 10 is exposed to in the course of routine use. Such features include temperature, pressure, salinity, pH, and chemical composition. In some instances, the environment 16 may substantially be an aqueous, briny fluid with high salt concentrations. The salt may be, for example, sodium chloride, potassium chloride, potassium bromide, calcium chloride, calcium bromide, zinc bromide, ammonium chloride, or a combination thereof. In some instances, the environment 16 may include a mixture of water and hydrocarbons. In some instances, the environment 16 may be approximately 10% water, 20% water, 30% water, 40% water, 50% water, 60% water, 70% water, 80% water, 90% water, 95% water, or 99% water by volume with the balance being one or more of hydrocarbons, salts, or other species.

In other instances, the material may be designed to degrade upon exposure to organic solvents, in which case the environment 16 may include one or more hydrocarbons. Also contemplated are substrates including two or more different degradable materials, such that when one material is degraded, but not the other, the substrate 14 breaks down into smaller pieces.

Examples of degradable materials include metals, metal alloys, ceramics, carbon-based plastics, and polymers. Some degradable metal alloys used in oilfield exploration, production, and testing may include alloys of alkali metals and alkali earth metals with other metals such as gallium (Ga), indium (In), zinc (Zn), bismuth (Bi), and aluminum (Al). Additionally, alloys based on magnesium (Mg) or iron (Fe), such as Mg—Al based alloys, Mg-RE (rare earth) based alloys, Mg—Ca based alloys, pure Fe, Fe—Mn alloys, zinc and bulk metallic glasses may be used. Non-limiting examples of degradable materials are described in U.S. Pat. No. 8,211,247 (“the '247 patent”), entitled “Degradable Compositions, Apparatus Comprising Same, and Method of Use.” Additional non-limiting examples of degradable materials are illustrated in U.S. Patent Application Publications Nos. 2016/0265094, 2016/0177661, 2017/0072465, 2015/0093589, 2015/0239795 and International Application No. WO 2015/184043.

The substrate 14 may also include other types of degradable materials, such as organic materials or composites of organic and inorganic materials. Non-limiting examples include nanomatrix powder metal compacts with Mg, Al, Zn, Mn, or combinations thereof, dispersed in the cellular nanomatrix, as described in U.S. Pat. No. 4,038,228, entitled “Degradable Plastic Composition Containing a Transition Metal Salt of a Highly Unsaturated Organic Acid,” or in water-soluble degradable synthetic vinyl polymers, as described in PCT Publication No. WO 2011/135,313, entitled “Water-Soluble Degradable Synthetic Vinyl Polymers and Related Methods.” Organic degradable materials include, for example, waxes, paraffin, polymers, polycaprolactone, polyesters and aromatic-aliphatic esters, poly-3-hydroxybutyrate, poly lactic acid (PLA), poly(ε-caprolactone) (PCL), polycaprolactone, cellulose-based materials, such as cellulose acetate and cellulose nitrate, polyesters (such as polylactic acid and polyglycolic acid), polyhydroxy butyrates, polyvinyl acetates, polyvinyl alcohols, polyacrylic acids, polyethylene glycol polysaccharides, polyvinyl chlorides, acrylonitrile butadiene styrene (ABS), polystyrene, polyethylene, or other materials. Additional non-limiting examples of degradable organic materials or composites are illustrated in International Application No. WO 2016/106134 and US 2014/0360728.

The degradable material (or materials) may be configured to degrade (when unprotected) within minutes, hours, days or weeks, as described in the '247 patent. For instance, the degradable material (or materials) substrate 14 may be configured to degrade within 1 second, 2 seconds, 3 seconds, 4 seconds, 5 seconds, 10 seconds, 20 seconds, 30 seconds, 40 seconds, 50 seconds, 1 minute, 2 minutes, 3 minutes, 4 minutes, 5 minutes, 10 minutes, 20 minutes, 30 minutes, 40 minutes, 50 minutes, 1 hour, 2 hours, 3 hours, 4 hours, 5 hours, 6 hours, 12 hours, 24 hours, 1 day, 2 days, 3 days, 4 days, 5 days, 6 days, 1 week, 2 weeks, 3 weeks, 4 weeks, 1 month, 2 months, 3 months and so on, also as described in the '247 patent.

The degradable material may be degraded, decomposed, disintegrated or corroded in an environment, including, but not limited to, water, aqueous solutions, brine solutions, acidic solutions (such as those containing hydrochloric acid, sulfuric acid, hydrofluoric acid, phosphoric acid, or precursors of these acids, and combinations thereof), caustic solutions (such as aqueous solutions of sodium hydroxide, potassium hydroxide, and combinations thereof), water-based muds, chemical solvents (such as acetone, isopropanol, benzene, ethylbenzene, toluene, methanol, ethanol, xylene, kerosene, gasoline, diesel fuel, biodiesel fuel, tetrahydrofuran, and combinations thereof), or oil-based muds. The onset of degradation is often followed by the formation of degradation products, leading for example to a rise or drop in the concentration of one or more ionic species, the generation of gas bubbles from the degrading material, and/or changes in color to the tool or surrounding environment.

The Barrier

The barrier 12 encapsulates or substantially encapsulates the substrate 14, to which it may be applied in such a way as to be free of pinholes, gaps, and voids. For instance, the barrier 12 may have a thickness of about 1 nm to about 100 nm, about 100 nm to about 1 μm, about 1 μm to about 10 μm, about 10 μm to about 100 μm, about 100 μm to about 1 mm, or about 1 mm to about 10 mm.

The barrier 12 may include a protective coating and/or a surface treatment or modification that protects the substrate 14. The coating may include one or more of an organic or inorganic material. In some instances, the barrier 12 may include one or more coatings, in parallel or layered on top of one another. For example, the barrier 12 may include one or more of the following: a) a homogenous solid or gel (for example, a hydrogel or aerogel) material, b) a heterogeneous and a composite of more than one solid and/or gel materials, and c) a plurality of coatings and a first portion of the coatings may be homogenous, while a second portion of the coatings may be heterogeneous.

The barrier 12 may include several layers that serve different functions. For example, a first layer may provide a pinhole-free barrier to the environment 16, while a second layer on top of the first layer protects the first layer from mechanical abrasion. Separately, a single barrier may serve both purposes of protecting the degradable material and providing mechanical robustness. In example barriers, the combination of two coatings may result in a combined permeability of both layers that effectively controls the degradation rate of the substrate 14. In addition, the second coating can supplement the first coating with added functionalities by including materials such as hydrogels, organogels, aerogels, ceramic epoxy resins, silicon dioxide, titanium dioxide and any organic-inorganic hybrid materials suitable as coating layers for added protection, including but not limited to corrosion resistance, mechanical degradation resistance, and other structural and chemical protections.

An inner layer in contact with the degradable substrate 14 may substantially dissolve in the environment 16 while an outer layer protects the bottom layer from direct exposure to the environment 16. Upon breach of the top layer, the bottom layer dissolves and allows degradation of the underlying degradable substrate 14 from virtually all directions/all surfaces.

In certain instances, the barrier 12 may be permeable to one or more chemical species that may trigger or sustain the degradation of the substrate 14. Depending on the nature of the substrate and the conditions under which degradation occurs, such species may be one or more solvents, ions, organic molecules or biological compounds. The barrier 12 may have sufficiently low permeability for one or more species such that the exchange of a chemical species between the substrate 12 and the surrounding environment 16 occurs at a low enough rate to prevent decomposition of the substrate 12 during its intended lifetime. In some embodiments, the barrier 12 may have low enough solubility in the environment 16 such that the integrity of the barrier 12 is maintained for the desired lifetime of the substrate 14. In other embodiments, the melting point of the barrier 14 can be sufficiently high such that the integrity of the barrier is maintained for the desired lifetime of the substrate 12 in the surrounding environment 16.

Additional examples of the barrier 12 may include one or more layers formed from materials such as plastics, ceramics, metals, and polymers. Example polymers include: fluorinated polymers such as polytetrafluoroethylene (PTFE), polyvinylidene fluoride (PVDF), poly(perfluorodecylacrylate) (PFDA), poly(perfluorononyl acrylate), poly(perfluorooctyl acrylate), poly(3,3,4,4,5,5,6,6,7,7,8,8,8-tridecafluorooctyl methacrylate), poly(1H,1H,2H,2H-perfluorooctyl acrylate), poly([N-methyl-perfluorohexane-1-sulfonamide]ethyl acrylate), poly([N-methyl-perfluorohexane-1-sulfonamide]ethyl(meth)acrylate), poly(2-(perfluoro-3-methylbutyl)ethyl methacrylate)), poly(2-[[[[2-(perfluorohexyl)ethyl]sulfonyl]methyl]-amino]ethyl]acrylate), poly(2-[[[[2-(perfluoroheptyl)ethyl]sulfonyl]methyl]-amino]ethyl]acrylate), poly(2-[[[[2-(perfluorooctyl)ethyl]sulfonyl]methyl]-amino]ethyl]acrylate), poly(p-xylylene) polymers, such as parylene-N, parylene-C, parylene-D, parylene-HT, and parylene copolymers, silicones, such as Sylgard 184 (Dow Corning, Auburn, Mich.), and blends thereof, acrylates, such as Tech Spray Turbo-Coat Acrylic Conformal Coating ((Tech Spray, Kennesaw, Ga.), poly(octadecyl acrylate), polymethylmethacrylate (PMMA), polyglycidylmethacrylate (PGDMA), poly-2-hydroxyethylmethacryalte, poly(hexyl acrylate), poly(hexyl methacrylate), poly(cyclohexyl acrylate), poly(cyclohexyl methacrylate), and any copolymer thereof, and may be cross-linked with a member selected from the group consisting of ethylene glycol diacrylate, ethylene glycol dimethacrylate, diethylene glycol divinyl ether, 1H,1H,6H,6H-perfluorohexyldiacrylate, diethyleneglycol divinyl ether, and divinyl benzene (DVB).

Further examples of the barrier 12 may include materials such as diamond-like carbon, SiO2, SiN, TiO2, TiN, SiC, cyclic siloxanes such as 1,3,5-trivinyl-1,3,5-trimethylcyclotrisiloxane (V3D3), or impermeable polymers such as copolymers of 4-aminostyrene and maleic anhydride, as described in U.S. Pat. No. 8,552,131, entitled “Hard, Impermeable, Flexible and Conformal Organic Coatings.” In further embodiments, the barrier 12 may include a metal, such as Gold (Au), Chromium (Cr), Aluminum (Al), Platinum (Pt), Copper (Cu), or Nickel (Ni). The barrier 12 may also include a gel (hydrogel, aerogel), a membrane such as a polar membrane composed of a lipid bilayer, or of a carbon nanotube or graphene based membrane.

Slow-Acting Trigger

The degradation of the substrate 14 may be initiated and sustained by contact with chemical species in the environment 16. The barrier 12 can therefore be used to modify the degradation rate and/or the degradation delay of the substrate 14 by controlling the exposure of the substrate to the environment 16. This exposure can be controlled by adjusting the fraction of the surface area of the substrate which is in direct contact to the environment. The exposure may also be controlled by changing the rate at which the chemical species in the environment arrive at the substrate surface, or vice versa.

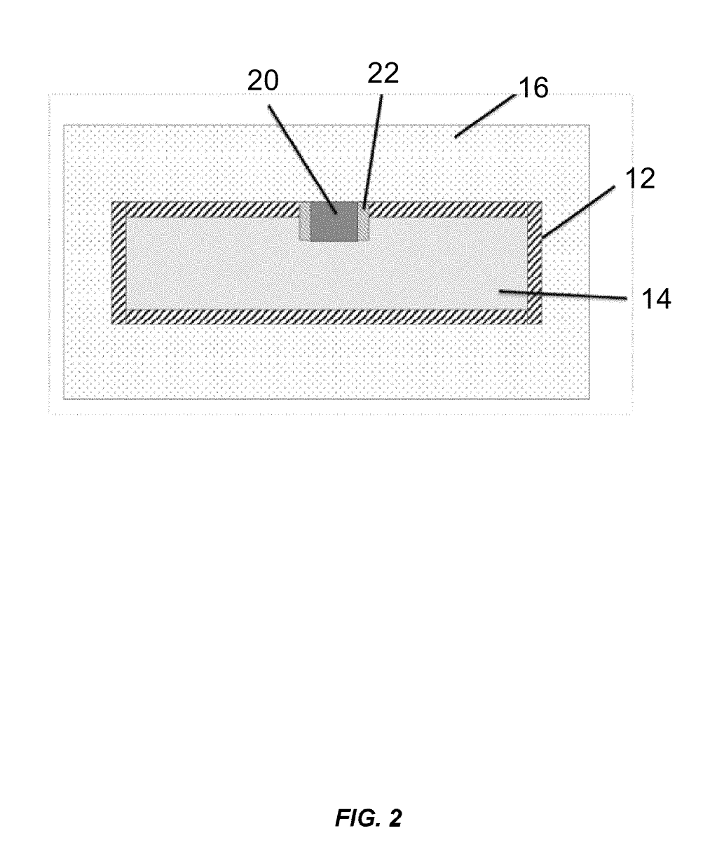

FIG. 2 schematically illustrates the use of a slow-acting trigger 20 that can be implemented in the barrier 12 that is protecting substrate 14 from environment 16. In some embodiments, the slow trigger 20 does degrade, dissolve, disintegrate, or corrode in the same environment(s) that degrade, dissolve, disintegrate, or corrode the degradable substrate 14. In some embodiments, the slow trigger 20 includes a degradable material, for example the same material or substantially same material as the degradable substrate 14. In a number of instances, the slow trigger 20 may be a distinct material from the substrate 14. The slow trigger 20 may also include a degradable polymer and/or a degradable metal.

The degradation characteristics of the slow trigger 20 can be chosen to meet requirements for use in its intended downhole environment. For example, the slow trigger 20 may be configured in a way as to compensate for increased degradation rates resulting from higher downhole temperatures. Also contemplated are configurations where the trigger 20 degrades at a rate affected by temperature, salinity, pH and/or pressure. One or more physical dimensions of the trigger 20 may be varied for uses in different temperature ranges, salinity, pH, and/or pressure.

In some example instances, the slow trigger 20 may be an exposed portion of the degradable substrate 14 that protrudes from the bulk substrate and is not covered by the protective barrier 12. Alternatively, the slow trigger 20 may be a defect in the barrier 12 that exposes a region of the degradable substrate 14. The slow trigger 20 may be a defect in the barrier 12 created by locally removing a section of the barrier 12 through mechanical abrasion of the barrier 12, such as punctuation or scratching, which could be achieved through contact of the barrier 12 with a sharp object. In some embodiments, the slow trigger 20 may be a section of the barrier 12 locally removed by melting a portion of the barrier 12 using heat or irradiation, such as with a laser. The barrier 12 may be prevented from adhering to a portion of the substrate 14 during deposition of the protective barrier 12. For example, this can be accomplished by masking off a surface on the substrate 14, coating the entire part, and then removing the mask. The barrier 12 may be prevented from depositing on a portion of the substrate 14 during deposition of the protective barrier 12. For example, a chemical inhibitor, such as a radical scavenger, can be applied to a portion of the substrate 14 to prevent local deposition of the coating. In some examples, the slow trigger 20 is embodied as the barrier 12 that is itself dissolvable or degradable.

In some configurations, the slow trigger 20 may feature a single or multiple individual components exposed to environment 16. The slow trigger 20 can be any geometry and shape, including a rod, a tube, a block, a sphere, and/or any other possible shape or combinations thereof. In one example, the slow trigger 20 extends the entire way through the bulk of the substrate 14 to expose the slow trigger 20 on both sides of the substrate 14. Upon exposure to the environment 16, the slow trigger 20 will begin to degrade in at least two locations, which allows the environment 16 to begin degrading the substrate 14 from within the inner bulk of the substrate 14.

The slow trigger 20 may be implemented with a sealing means 22, such as an o-ring that protects the substrate 14 from the environment 16. In some embodiments, the sealing means 22 may be a sealing adhesive in the barrier 12 that is protecting substrate 14 from environment 16. In some instances, the sealing means 22 may degrade, dissolve, disintegrate, or corrode in the same environment 16 as the degradable substrate 14. Alternatively, the sealing means 22 may remain intact while the slow trigger 20 degrades, dissolves, disintegrates, or corrodes in the same environment 16 as the degradable substrate 14.

Fast-Acting Trigger

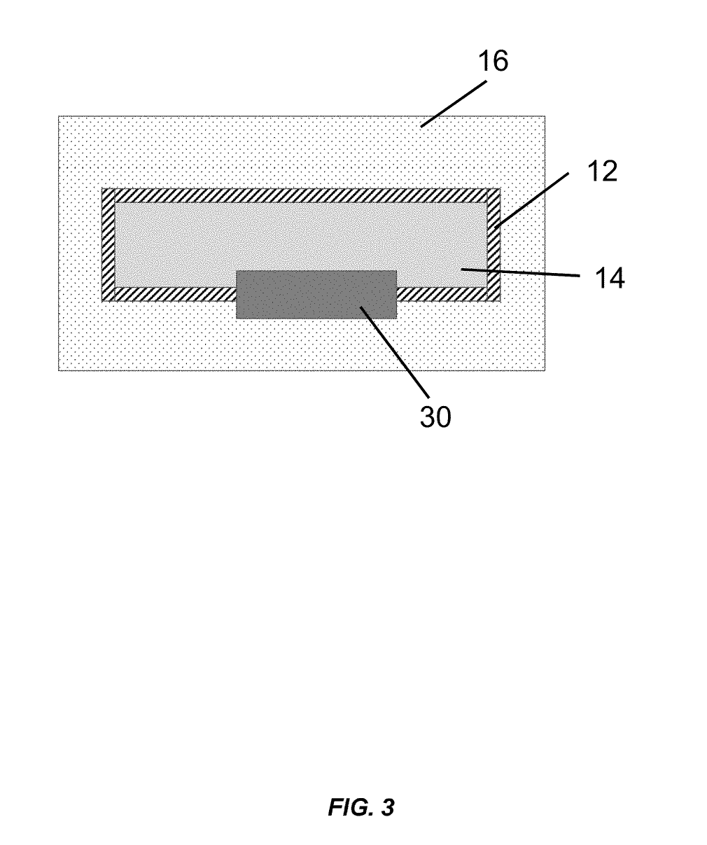

FIG. 3 illustrates a fast-acting trigger 30 implemented in the barrier 12 disposed on the substrate 14. The fast-acting trigger 30 includes a mechanism that causes or facilitates the timing, functions and/or properties of the barrier 12 in respect to the degradation behavior of the underlying substrate 14. Depending on the environment 16 and the requirements of the application at hand, the trigger 30 can be remotely activated or programmed to time the onset of degradation of the substrate 14 which can be thus delayed or accelerated.

In certain configurations, the fast trigger 30 covers and seals a breach, gap, or defect in the barrier 12. The breach, gap, or defect in the barrier 12 may be made by applying the barrier 12 to the surface followed by locally scratching, cutting or melting the barrier off (e.g., laser cutting). The breach, gap, or defect in the barrier may be made with a laser, a knife, a blade, or another sharp object. In some instances, the barrier 12 can be prevented from adhering to a portion of the substrate 14 during deposition of the protective barrier 12. For example, this can be accomplished by masking off a surface on the substrate 14, coating the entire part, and then removing the mask. In some instances, the barrier 12 may be prevented from depositing on a portion of the substrate 14 during deposition of the protective barrier 12. For example, a chemical inhibitor such as a radical scavenger can be applied to a portion of the substrate 14 to prevent local deposition of the coating.

In downhole tools having a barrier such as 12, fast-acting trigger 30 can activate and thus initiate the degradation of the substrate 14 at a time of the user's choosing and within a relatively short time frame. This contrasts with tools like traditional degradable plugs, which usually lack a protective barrier and begin degrading as soon as introduced in the downhole environment. The fast trigger may be activated when exposed to an organic solvent, and its activation can induce the substrate 14 to be exposed to the environment 16 or at least to some of the chemical species present in environment 16. For example, the fast-acting trigger 30 may detach from the other components of the tool 10 when activated, exposing the substrate 14 to downhole environment aqueous compositions such as brine and initiating its degradation. In some embodiments, exposure of the fast-acting trigger 30 to an organic solvent results in a change in the chemical properties, physical properties, or both of the material of the trigger 30. This in turn results in exposure of the underlying substrate 14 to the environment 16. For example, upon exposure to organic solvent the fast trigger 30 may undergo one or more of swelling, gelling, softening, dissolution, etching, reacting, shrinking, delamination, cracking, crazing, shape change, or permeability change.

It has been found that, in instances where the fast trigger 30 includes certain materials, the organic solvent induces delamination of the trigger from the other components of the tool 10. Without wishing to be bound to any particular theory, it is believed that, at least in some cases, when the fast trigger includes a material that exhibits a swelling percentage (either by weight, volume, or both) of at least 2.5% upon exposure to the organic solvent, delamination and detachment from the other components of tool 10 occur at a high enough rate as to enable a rapid activation of the trigger and a quick onset of the degradation of the substrate 14.

In some instances, the material may exhibit a swelling percentage of at least 1%, at least 2.5%, at least 5%, or at least 10% (either by weight, volume, or both) following exposure to the organic solvent for a given amount of time. In other instances, the swelling percentage is at least 15%, or at least 25%. The swelling percentage may also be at least 50%, at least 100%, at least 200%, or at least 300%. Moreover, the material and solvent may be chosen to time the activation of the fast trigger 30 at specific intervals following exposure to the organic solvent. Thus, in some embodiments, the trigger may be set to activate within as little as 5 seconds after exposure to the organic solvent, while in other embodiments activation may require 5, 10, 20, 30, or even 60 minutes or more of exposure.

In instances where the material undergoes gelling or softening, the material may exhibit a decrease in modulus of at least 1%, at least 2.5%, at least 10%, at least 15%, at least 25%, at least 50%, at least 100%, at least 200%, or at least 300%. If the material undergoes dissolution, etching, reacting, or shrinking, the material may exhibit a loss in volume or mass of at least 1%, at least 2.5%, at least 10%, at least 15%, at least 25%, at least 50%, or at least 100%. In embodiments where the material undergoes delamination, cracking, crazing, or shape change, the area of contact between the fast trigger 30 and the other components of the tool 10 may diminish by at least 1%, at least 2.5%, at least 10%, at least 15%, at least 25%, at least 50%, or at least 100%. In applications where the material undergoes a change in permeability to one or more of the components of the downhole environment 16 and/or to one or more of the components of the substrate 14, for example a change in water permeability, such change in permeability may be of at least 1%, at least 2.5%, at least 10%, at least 15%, at least 25%, at least 50%, or at least 100%.

Following activation of the fast trigger 30 by exposure to organic solvent, the degradation of the substrate 14 or a portion thereof commences upon subsequent exposure to brine, for example when the downhole environment 16 comes into contact with the substrate 14 through a gap in the barrier 12 that has been exposed by the activation of the trigger 30. Accordingly, components of the downhole environment 16 that induce degradation of the substrate 14 or a portion thereof, such as briny wellbore fluids or the organic solvent itself, may come into contact with the substrate 14 and degrade it. For instance, the fast trigger 30 may be fashioned with a thickness and/or geometry such that, following exposure to the organic solvent for a time required for trigger activation, substrate degradation commences within 30 minutes of exposure to brine introduced into the wellbore after the trigger has been activated. Also contemplated are instances where the fast trigger 30 is activated upon contact with an aqueous fluid and the substrate 14 degrades when exposed to an organic solvent.

In some examples of the tool, the fast-acting trigger 30 includes an elastomer that covers the defect in the barrier 12. For instance, the fast-acting trigger 30 may include a combination of multiple layered materials or a composite of multiple components in which one material is used to cover the defect in the barrier 12. Exemplary fast trigger materials include polymers such as polyurethanes, silicones (also known as polysiloxanes), polyacrylates, polyepoxides, waxes, and combinations thereof. Example organic solvents include: ketones such as acetone, alcohols such as methanol, ethanol, propanol, and isopropanol, ethers such as tetrahydrofuran and dioxane, and biodiesel fuel. Other example solvents hydrocarbons such as benzene, ethylbenzene, toluene, xylene, gasoline, diesel fuel, and kerosene, either alone or as part of drilling fluids such as oil-based mud.

The fast trigger 30 may be any shape compatible with the desired activation profile of the trigger. The tool may feature more than one fast triggers, and the orientation, size, shape and number of fast triggers may be used to control degradation rates. Additionally, multiple different materials may be used as the fast trigger on the same device. The barrier defect may be any shape, including, but not limited to a dot, circle, straight line, curved line, angled line, or combination thereof. The barrier defect may also be disposed in a groove to prevent damage or physical delamination of the elastomers from the substrate. The shape of this groove may be a dot, circle, straight line, angled line, curved line, or combination thereof.

Multiple Trigger Tool

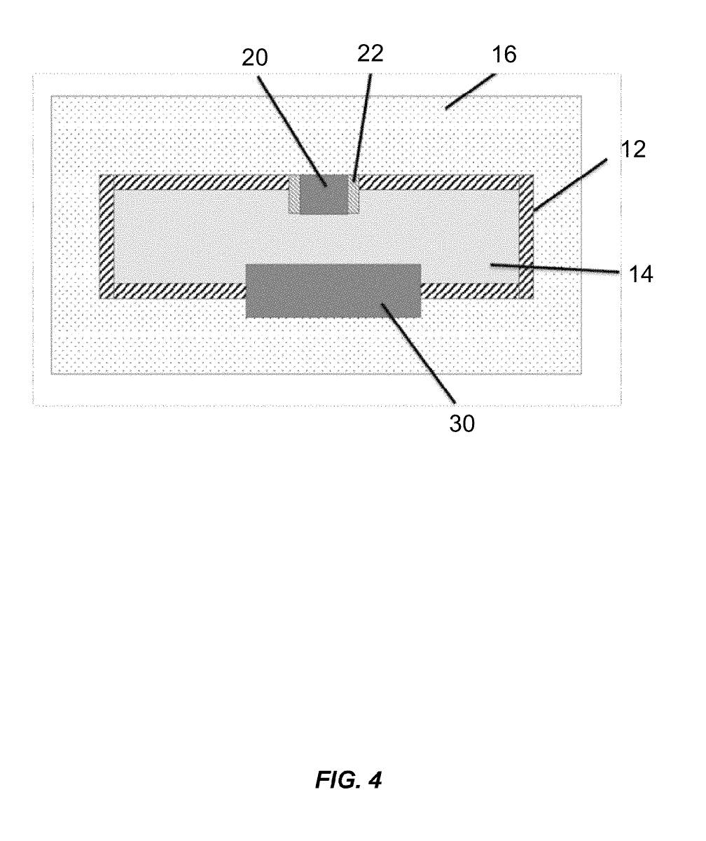

FIG. 4 shows a schematic illustration of a degradable substrate 14 protected by a barrier 12 from environment 16. The tool 10 features a fast trigger 30 and a slow trigger 20. Multiple triggers 20 and 30 can be used to modify the degradation rate of the substrate 14, for example by increasing contact and surface exposure to the environment 16.

Each of the triggers 20 and 30 may be configured to respond substantially differently upon exposure to different environments, and thus the exposure of the degradable substrate 14 to the environment 16 may be controlled by modulating the properties of the environment 16. For example, the slow trigger 20 can be configured to degrade and expose the underlying degradable substrate 14 at time X when exposed to an aqueous solvent, but may be substantially stable (i.e., does not degrade) when exposed to an organic solvent. Conversely, the fast trigger 30 can be configured to expose the underlying substrate 14 at time Y when exposed to the organic solvent, but is stable (i.e., does not degrade or swell) when exposed to the aqueous solvent.

The fast trigger 30 may be configured so that the activation time Y occurs in 10 seconds, 20 seconds, 30 seconds, 1 minute, 2 minutes, 5 minutes, 10 minutes, 15 minutes, 20 minutes, 30 minutes, 40 minutes, 50 minutes, 1 hour, 2 hours, 3 hours. The slow trigger 20 may be configured so that the activation time X occurs in 1 hour, 2 hours, 3 hours, 4 hours, 5 hours, 6 hours, 7 hours, 8 hours, 9 hours, 10 hours, 12 hours, 13 hours, 14 hours, 15 hours, 16 hours, 18 hours, 30 hours, 45 hours, 60 hours, 75 hours, 90 hours, or over 90 hours. In some embodiments, the ratio of the activation times of the slow trigger to the fast-acting trigger, X/Y, is 2; 5; 10; 100; 500; 1,000; 5,000; 10,000; 100,000; or 1,000,000. Thus, this selective nature affords the user significant control over the timing of the degradation of the substrate 14 by selection of the environment 16 surrounding the tool 10.

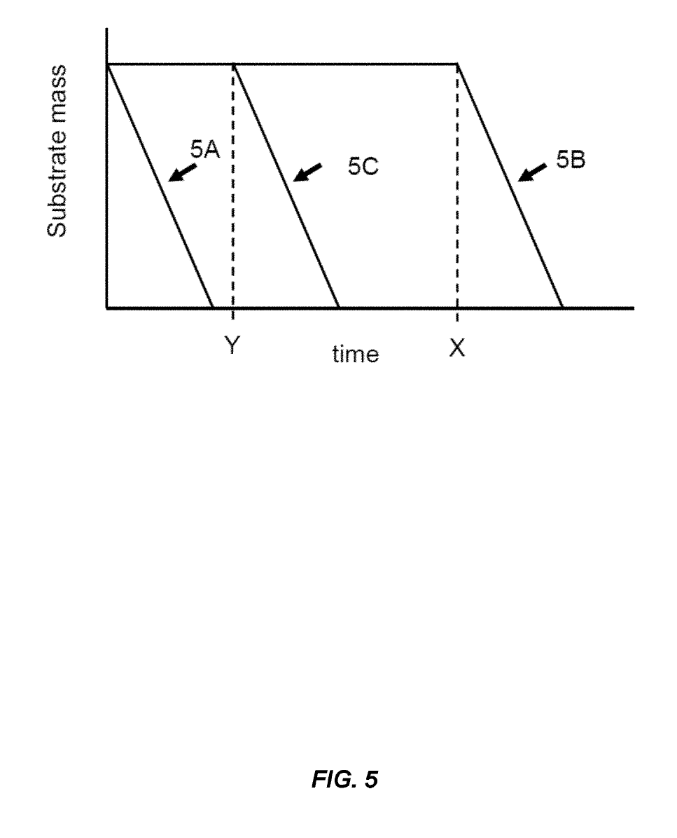

FIG. 5 shows exemplary degradation profiles of a degradable material that illustrates the use of a barrier 12 and triggers 20 and 30 to control and/or modify the degradation behavior and degradation start time of a degradable substrate 14. In the figures, the mass of the degradable material of substrate 14 is plotted as a function of time, with the vertical axis showing the total mass of the substrate 14 and the horizontal axis showing the time when the mass is measured.

Line 5A illustrates an exemplary degradation profile without any modification to the substrate 14 and without any type of barrier. Although the degradation profile 5A is shown as a linear reduction of mass over time, the degradation profile can take any shape or form, including but not limited to a linear, logarithmic or exponential decaying profile. Without a protective barrier coating, substrate 14 immediately begins degrading upon exposure to the environment 16.

Line 5B illustrates an exemplary degradation profile of a degradable substrate 14 with an addition of a barrier 12 and slow trigger 20. Profile 5B shows that between time t=0 and time t=X, substrate 14 experiences no loss in mass and denotes a delay in degradation of substrate 14. Note that this may not include the mass of the slow trigger 20. The degradation profile 5B is also shown as a simple linear reduction of mass over time, but the profile may also be logarithmic, exponential or some other form of decay.

Line 5C illustrates an example degradation profile of the degradable substrate 14 with the addition of a barrier 12 and fast-acting trigger 30 for a faster onset of degradation of substrate 14. In this scenario, a fluid activating the trigger is added to the wellbore fluids of environment 16, causing fast trigger 30 to be activated at time t=Y, exposing substrate 14 to environment 16. As described herein, breach times Y<X.

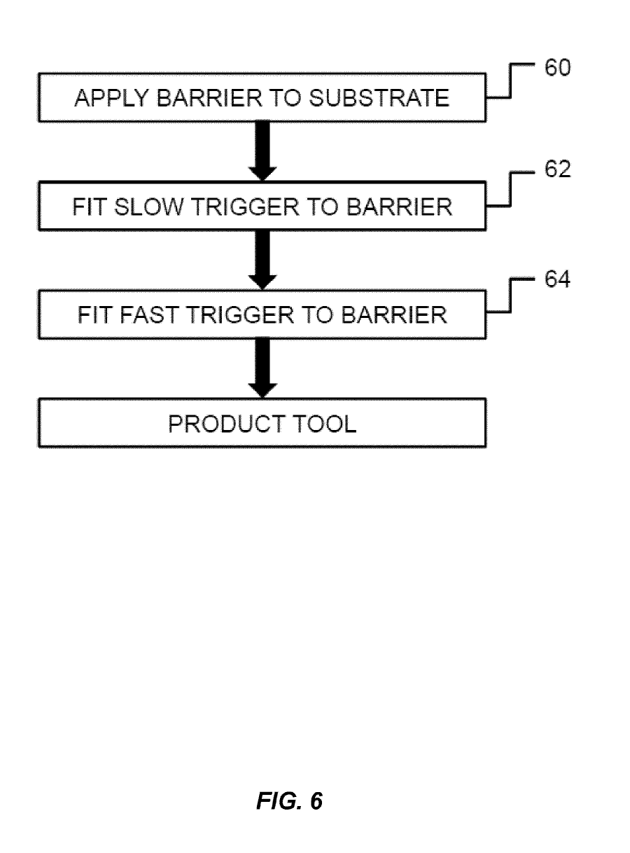

FIG. 6 illustrates an example method for manufacturing a device such as the tool 10. A barrier is applied to a substrate including one or more degradable materials (60). A slow trigger (62) and a fast trigger (64) are then each fitted to a breach, gap, or defect in the barrier, forming the product tool.

The barrier 12 may be deposited on the substrate 14 using any number of widely used coating techniques including, but not limited to, chemical vapor depositions (including initiated CVD, hot-wire CVD, plasma enhanced CVD, and other forms of CVD), physical vapor deposition, sputter deposition, magnetron sputtering, radio frequency sputtering, atomic layer deposition, pulsed laser deposition, electroplating, dip-coating, brushing, spray-coating, sol-gel chemistry (through dip-coating, brushing or spray-coating), electrostatic spray coating, 3D printing, spin coating, electrodeposition, powder coating, sintering, self-assembly of monomers, and self-assembly of particles. The barrier 12 may also be applied by dipping the entire substrate 14 into a liquid that then hardens to form a “cast” either after removal from the liquid or in a mold that is holding the liquid. Any excess material can then be removed to achieve the desired overall part dimensions by machining, grinding, cutting or another technique.

The properties of the barrier 12 may be optimized during the deposition process by varying deposition parameters. Physical properties such as, for example, coating texture, coating thickness, thickness uniformity, surface roughness, porosity and general mechanical elastic properties, including fracture toughness, ductility, and abrasion resistance can be optimized via fine tuning of deposition parameters. Chemical properties such as, for example, chemical resistance and corrosion resistance (from acids, bases and salts), along with other chemical properties, including specific reactivity, adhesion, affinity, hydrophobicity, and hydrophilicity may also be optimized. Various physical and chemical properties of the barrier 12 may be further improved or modified post deposition by a subsequent surface or temperature treatment, such as annealing, rapid-thermal (flash) annealing, exposure to radicals, or UV exposure.

The barrier 12 may sufficiently bond to the substrate 14 such that it can withstand mechanical abrasion during transportation and deployment. Further abrasion resistance can be provided by additional coating layers deposited on top of the first layer. In some embodiments, the barrier 12 can be covalently grafted to the surface of the substrate 14. This deposition approach may be accomplished using a vinyl precursor such as: trichlorovinylsilane, bis(triethoxysilylethyl)vinylmethyl-silane, 3-(trimethoxysilyl)propyl methacrylate, 1,2-bis(triethoxysilyl)ethylene, bis(trimethoxysilylmethyl)ethylene, 1,3-[bis(3-triethoxysilylpropyl)poly-ethylenoxy]-2-methylenepropane, bis [(3-trimethoxysilyl)propyl]-ethylenediamine, bis [3-(triethoxysilyl)propyl]-disulfide, 3-mercaptopropyltrimethoxysilane, and vinyl phosphonic acid. The formation of reactive surface sites on the barrier 12 or the substrate 14 may be achieved using plasma activation or exposing to a plurality of free radical species, as described in U.S. Patent Publication No. 2013/0280442, entitled “Adhesion Promotion of Vapor Deposited Films.”

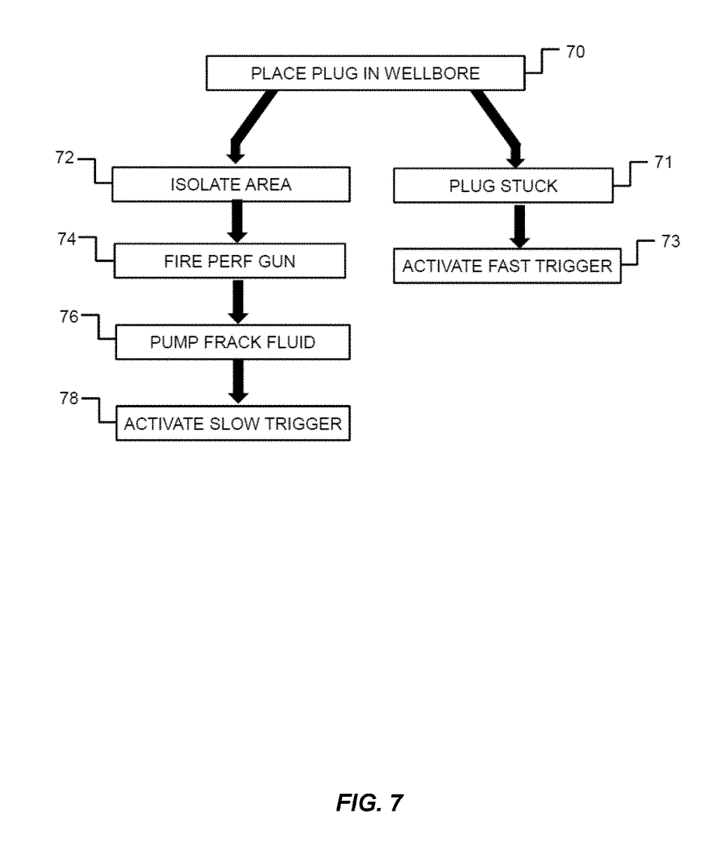

FIG. 7 illustrates an example application where the tool 10 is a plug used in “plug-and-perf” applications for hydraulic fracking. The plug is placed or pumped down to a desired position in the wellbore (70) to isolate the area to be perforated from previously perforated and hydraulically fractured sections downhole of the plug (72). In case of malfunction, for example if the plug becomes stuck before reaching its intended position in the wellbore (71), it can be rapidly disposed of by activating the fast trigger, for instance via injection of an organic solvent in the wellbore (73). Subsequent exposure to brine after activation will result in degradation of the plug. In the case that no malfunction occurs, the plug is set at its intended location downhole that allows it to isolate a section of the wellbore (72). Once the plug is set, an explosive charge may be ignited in a “perf gun”, penetrating the reservoir section (74). Then hydraulic fracking takes place, and frack fluid is pumped into the same section (76). The process is repeated for each section, until all have been fracked. The slow trigger slowly degrades during routine operations as the plugs are subjected to aqueous briny solutions, ultimately resulting in degradation of the plugs (78).

### EXAMPLES

### Example 1: Protective Barrier Coatings

Various coating chemistries were applied to blocks of degradable metal alloy to test their performance as protective barriers. Chemical vapor deposition (CVD) was used to apply some of the polymer coatings. In some experiments, initiated chemical vapor deposition (iCVD) of cyclohexyl methacrylate (CHMA) and ethylene glycol diacrylate (EGDMA) was used to deposit multilayer coatings. CHMA and EGDMA monomers were flowed into a vacuum reaction chamber at flow rates of 1 and 0.1 sccm (standard cubic centimeter per minute), respectively. Tert-butyl peroxide initiator was flowed at a rate of 1 sccm. Samples of degradable material were placed on a stage maintained at 30° C., the filament temperature was approximately 250° C., and the chamber pressure was 300 mTorr. The EGDMA valve was closed periodically to create alternating multilayer stacks of copolymer and CHMA homopolymer. The samples were turned over after coating and the process was repeated. In other experiments, additional types of coatings were deposited by chemical vapor deposition by adapting the deposition times, pressure, reactor configuration, precursors, precursor flowrates and other parameters.

Samples of degradable material were also coated by spraying with Turbo-Coat Acrylic Conformal Coating (Tech Spray, Kennesaw, Ga.) on both sides and drying at 65° C. for 25 minutes. The process was repeated twice on each sample.

In another experiment with coatings, a 100 mL volume of Sylgard 184 (Dow Corning, Auburn, Mich.) precursor was prepared by mixing a 10:1 ratio of elastomer to curing solution followed by 60 minutes of degassing under vacuum. Samples of degradable material were then fully submerged into the precursor under ultrasonication for a duration of 1 minute. The samples were then degassed for an additional 60 minutes before curing in an oven at 75° C. for 24 hours. In a further experiment, samples of degradable material were first treated by dip coating in Sylgard 184 precursor as described above. A solution of 50 wt % octadecyl acrylate and 5 wt % trimethylolpropane trimethacrylate was prepared in toluene and heated to 40° C. While the solution was sonicated, samples of degradable material were fully submerged into the solution for a duration of 1 minute. The samples were then placed into a custom curing chamber where they were placed under vacuum and exposed to tert-butyl peroxide initiator that was heated by filaments set to 315° C. for 4 hours. The coated parts were submerged in approximately 5 wt % potassium chloride solution at 65° C. The time at which corrosion was first observed was noted, as shown in Table 1.

TABLE 1
Time to corrosion (hours) of degradable materials coated with different
chemistries applied with different methods and submerged in
approximately 5 wt % KCl aqueous solution at 65° C.

| | | | Time When |
|---|---|---|---|
| | Number | | Corrosion First |
| | of | Application | Observed |
| Coating Chemistry | Layers | Method | (hours) |
| CHMA/CHMA-EGDMA | 5 | Initiated chemical | >6 |
| copolymer | | vapor deposition | |
| CHMA/CHMA-EGDMA | 3 | Initiated chemical | >6 |
| copolymer | | vapor deposition | |
| CHMA/CHMA-EGDMA | 1 | Initiated chemical | 0.25 |
| copolymer | | vapor deposition | |
| CHMA/hexyl acrylate | 1 | Initiated chemical | 0.05 |
| copolymer | | vapor deposition | |
| Parylene-C | 1 | Chemical vapor | >6 |
| | | deposition | |
| Tech Spray Acrylic | 2 | Spray coat | 0.004 |
| Turbocoat | | | |
| Poly(octyldecyl acrylate) | 2 | Dip coat | >6 |
| and silicone layered | | | |
| coating | | | |
| Sylgard 184 Silicone | 1 | Dip coat | 0.083 |

### Example 2: Slow Trigger Mechanism

A degradable trigger material, precisely sized in shape, area, and thickness, was attached to cover a coating defect area in a parylene-coated degradable alloy part. When the part was subjected to a briny solution at warm temperature and at high pressure (similar to a wellbore environment), the trigger lost mass by reacting with the brine while the underlying degradable alloy stayed completely intact.

After a number of hours, a number of small pores were formed in the trigger material, allowing brine to breach the trigger and degrade the underlying degradable alloy. In order to prevent premature breach, the trigger was sealed to the coated degradable alloy part with an adhesive in such a way that the breach time was solely controlled by the trigger and not by any seal break events. After the breach occurred through the trigger material, the underlying degradable alloy was exposed to brine and began degrading.

After the breach of the trigger, the coating partially or entirely detached from the degradable alloy. This caused the underlying degradable alloy part to lose enough of its volume or shape that its original mechanical function was no longer enabled. Two slow trigger configurations were tested in which the triggers included identical degradable materials, sealed using identical methods, with a difference only in the thickness of the degradable materials. Breach times of two different slow trigger configurations in various environments are listed in Table 2. For some samples, the breach time of the slower triggers occurred between 6 and 12 hours under a warm salt brine solution at high pressure. In some instances, the breach of the slow trigger took approximately 4 hours, 10 hours, a day, or a few days, depending on a trigger's material, shape, area of some surfaces, area of all surfaces, thickness, or a combination of these elements under given environmental conditions, which might include a concentration of certain ions in fluid, a concentration of certain combinations of ions, temperature of fluid, pressure, or a combination of such conditions.

TABLE 2
Breach times for different trigger configurations in different environments

| Slow trigger | Solution | 1-10 wt % KCl in | |
|---|---|---|---|
| thickness | temperature | water | Saturated KCl in water |
| 1.5-3 mm | ≤100° F. | 50-60 hours | 24-30 hours |
| 1.5-3 mm | >100° F. | 6-12 hours | 5-10 hours |
| 3.5-5 mm | ≤100° F. | 75-90 hours | 36-45 hours |
| 3.5-5 mm | >100° F. | 12-18 hours | 10-14 hours |

### Example 3: Fast Trigger Mechanism

Aluminum blocks (2 inches×1 inch×¼ inches) were coated with parylene followed by the generation of a ½ inch-long linear defect on the coating, which allowed unhindered exposure to an environment. Soluble dyes were directly deposited on the coating defects. Sudan Black B was selected as the dye for all experiments performed using organic solvents, and Toluidine Blue was used for experiments performed using water. The dyes were fully encapsulated with a patch of one of six polymeric materials. Each sample was immersed in an aqueous solution to ensure no dye leakage occurred. After removing the samples from the aqueous solution, each aluminum block was submerged into one of eight solvents (200 mL) for a duration of six hours. Each block was monitored using a camera, which captured images at a rate of 1 minute/image. The images were then used to detect the dominant solvent-induced morphology changes to the encapsulating materials. These changes compromised the encapsulation of the dye, resulting in the infiltration by the solvent and subsequent removal of the dye. The dominant morphology that resulted in dye leakage for each polymer-solvent pair and as well as the patch breach times are reported in Table 3. The fastest polymer-solvent pairs resulted in almost immediate breach, with dye leakage occurring in less than 5 seconds. In other instances, some samples lasted more than 24 hours without any dye leakage. It should be noted that breach due to delamination refers to samples in which there was visible detachment of the patch, which may or may not have been a result of swelling of the patch material. For example, at least a portion of the patch may have separated from its substrate or other material as a layer of material (e.g., not dissolving). Breach due to swelling refers to samples in which swelling of the patch was observed without detectable delamination from the surface.

TABLE 3
Dominant morphology changes of various polymer-solvent pairs and
patch breach time (min)

| | | | | | | | | | | | | | | | 5 wt % | |
|---|---|---|---|---|---|---|---|---|---|---|---|---|---|---|---|---|
| | Toluene | | Xylenes | | Kerosene | | Gasoline | | Diesel | | Biodiesel | | Acetone | | KCI aq. | |
| | IT | | IT | | IT | | IT | | IT | | IT | | IT | | IT | |
| Polymer | (min) | MC | (min) | MC | (min) | MC | (min) | MC | (min) | MC | (min) | MC | (min) | MC | (min) | MC |
| Urethane | 4 | S | 53 | S | 60 | S | 35 | S | 23 | S | 167 | S | 7 | S | >360 | N |
| Silicone | <1 | D | <1 | D | 5 | S | <1 | D | 5 | D | 30 | D | 2 | D | >360 | N |
| PMMA | >360 | N | >360 | N | >360 | N | >360 | N | >360 | N | >360 | N | 40 | E | >360 | N |
| Cyanoacrylate | >360 | N | >360 | N | >360 | N | >360 | N | >360 | N | >360 | N | 2 | E | >360 | N |
| Paraffin | 27 | E | 10 | E | 22 | E | 15 | E | 40 | E | 143 | E | 174 | E | >360 | N |
| Epoxy | 40 | S | 15 | S | >360 | N | 150 | S | >360 | N | >360 | N | 20 | S | >360 | N |

IT = infiltration time,
MC = dominant morphology change leading to breach
N = no noticeable morphology change;
E = etching/dissolution;
D = delamination;
S = swelling

### Example 4: Example Fast-Acting Trigger Configurations

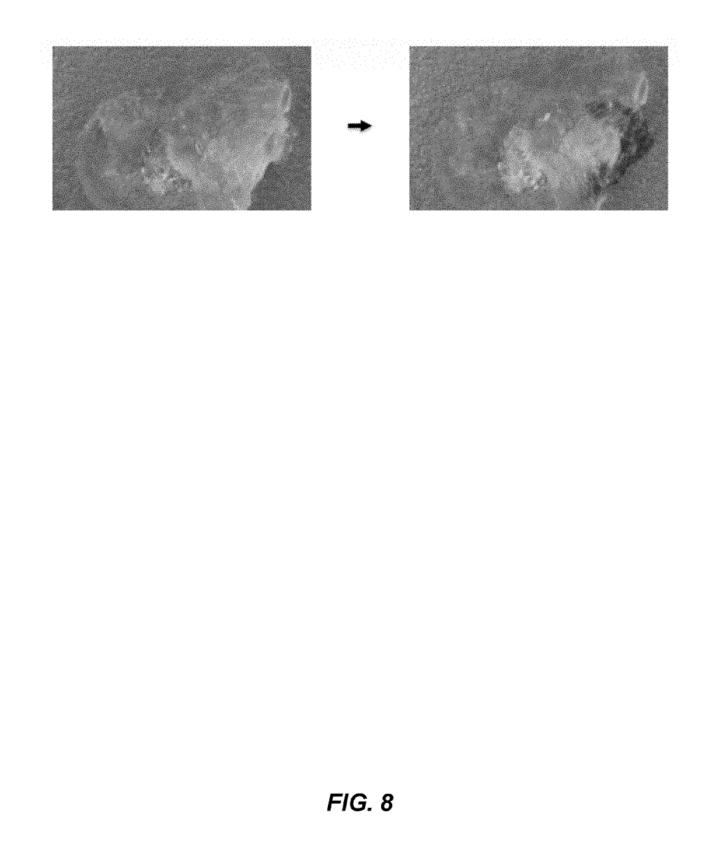

In one example, a small circular cutout was made in a parylene coating encapsulating a degradable metal alloy block. The cutout area was then patched by dispensing and curing a two-part epoxy formulation over it. The coated metal alloy block was then submerged in a 1-10 wt % sodium chloride solution with no indication of degradation of the underlying metal. This confirmed that the patch and parylene barrier coating successfully protected the underlying degradable alloy. The coated metal alloy block was then soaked for approximately one hour in toluene at 100° F. After the toluene soak, the patch partially adhered to the cutout area and partially exposed the underlying degradable alloy. The exposure was then confirmed by observing the onset of degradation of underlying alloy within a few minutes of being soaked in the same 1-10 wt % sodium chloride solution (FIG. 8). Degradation of the exposed surface was confirmed by the observation of generated bubbles and dark-colored byproducts.

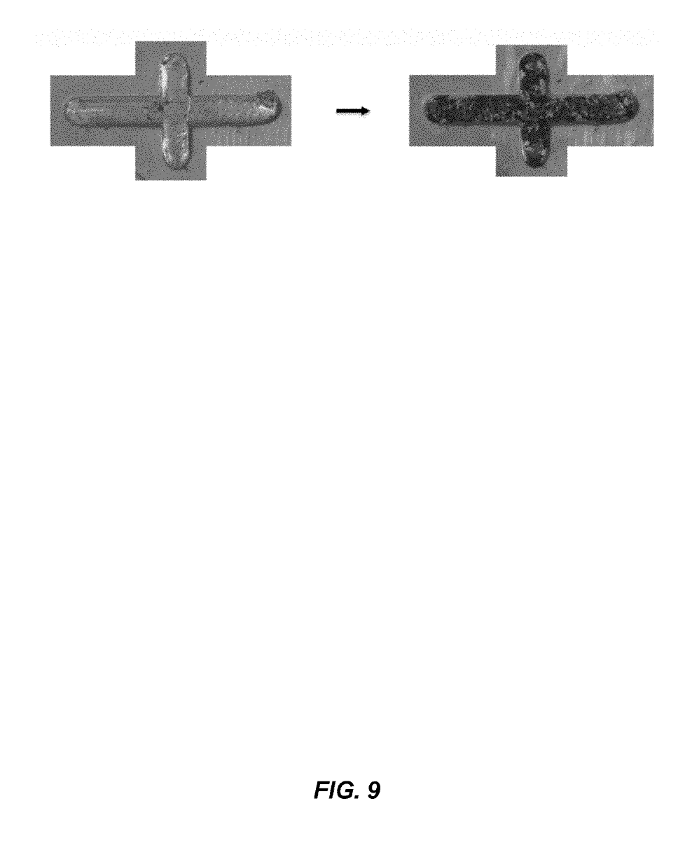

Additional specimens were created using silicone patches over different-sized cutouts on the same type of parylene-coated degradable metal alloy. The underlying degradable metal was protected from degradation by the silicone patches and parylene coating in a 1-10 wt % potassium chloride aqueous solution with temperatures ranging from room temperature to 155° F. and pressures ranging from atmospheric pressure to 1,000-2,500 psi. Then, the patched and coated metal parts were soaked in a mixture of hydrocarbons having chain lengths mostly of 7 carbon atoms and larger for 50 minutes. This resulted in exposure of the underlying degradable material. The exposure was confirmed by soaking the coated metal alloy in a 150° F., 1-10 wt % aqueous solution of potassium chloride for three minutes. The test confirmed degradation of the underlying degradable alloy (FIG. 9).

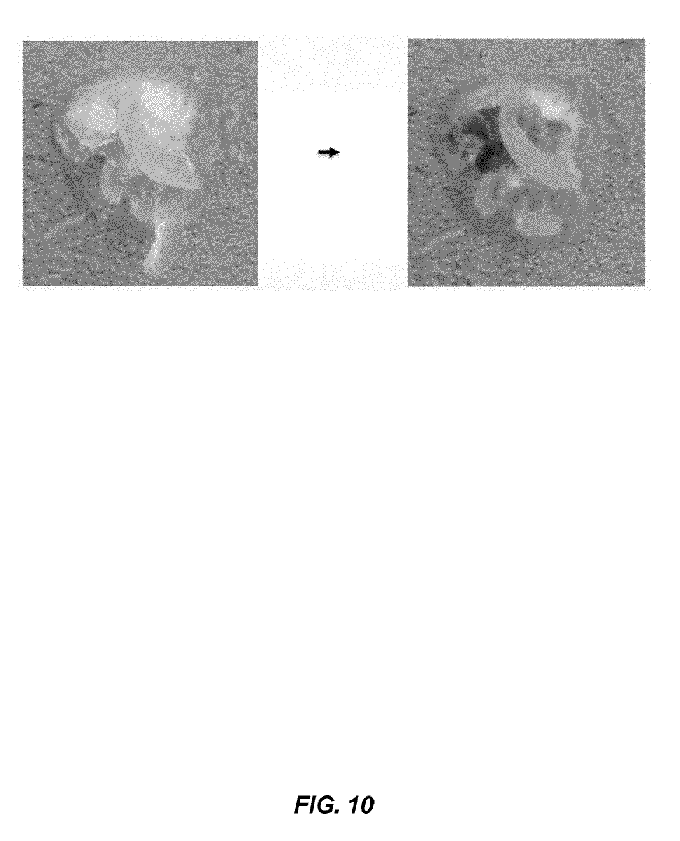

In another example, the patch placed over a cutout on a parylene-coated degradable alloy was a urethane. When the coated alloy was soaked in xylene for approximately one hour, the underlying degradable material was exposed. The onset of degradation was confirmed by exposure to a 1-10 wt % sodium chloride aqueous solution for a few minutes (FIG. 10).

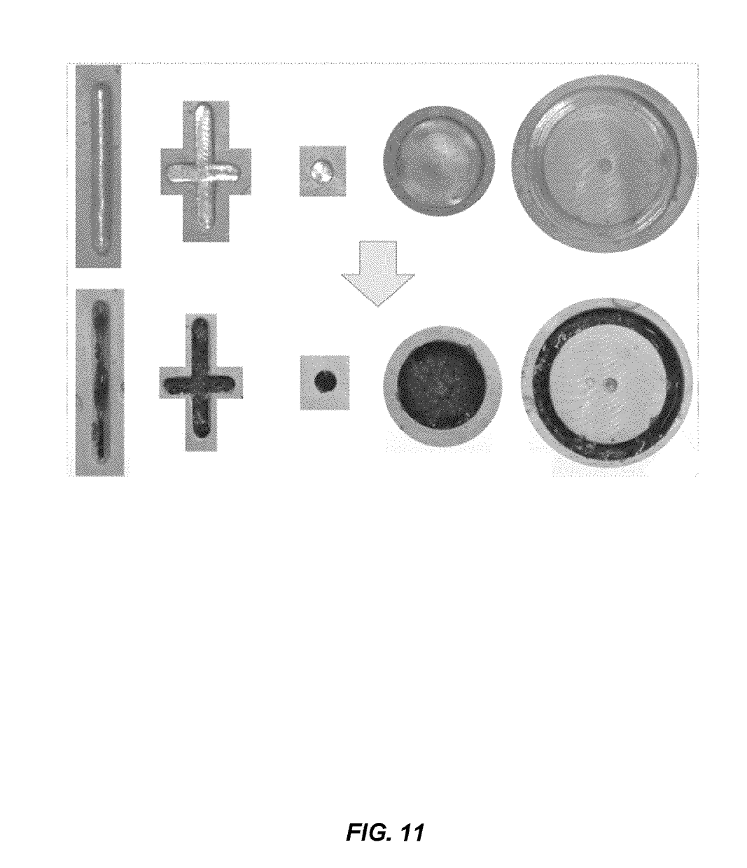

In a further example, some patches were applied to pre-shaped grooves. The grooves were characterized by different widths, lengths, and areas, for example, but not limited to, lines, curves, circular cutouts, crossing lines, and contours. Some of these examples are shown in FIG. 11. In some examples, silicone patches in differently shaped surface grooves on a parylene-coated degradable alloy completely delaminated by swelling when soaked in toluene, as shown in Table 4. As the silicone delaminated, the underlying uncoated degradable alloy surfaces were exposed. The degradable alloy parts with grooves were then soaked in 1-10 wt % warm potassium chloride brine. Degradation of the exposed surfaces was confirmed by the observation of generated bubbles and dark-colored byproducts.

TABLE 4
Delamination times for different shapes of silicone patches.

| Patch material | Patch shape | Fluid | Delamination time [min] |
|---|---|---|---|
| silicone | straight | toluene | 5 |
| silicone | cross | toluene | 11 |
| silicone | dot | toluene | 23 |
| silicone | disc | toluene | 28 |
| silicone | ring | toluene | 32 |

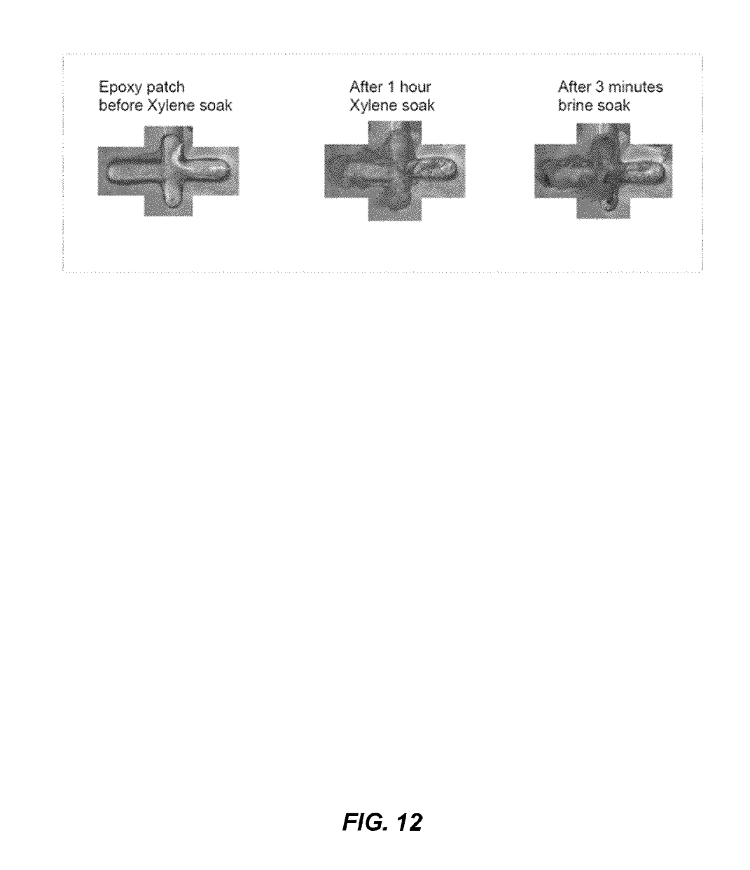

Another test showed that epoxy patches in a cross-shaped groove partially delaminated after approximately one hour in warm xylene, thereby exposing a small portion of the underlying degradable alloy. The small portion of exposed degradable alloy area began reacting when the sample was soaked in approximately 150° F. 1-10 wt % potassium chloride brine. As the sample dried after a few minutes of the brine soak, the degradation of material was confirmed by observing that a portion of the patched region turned black (FIG. 12).

### Example 4: Description of Combination Solution of Degradable Part Coated with Barrier and Two Fuses

In a preferred example, both a slow trigger material and a fast-acting trigger patch were applied on parylene-coated degradable metal alloy parts. When the parts were first soaked in warm 1-10 wt % KCl brine at high pressure (similar to a wellbore environment), the slower trigger material was continuously dissolved while the underlying degradable metal alloy was completely protected. During several hours of soaking in brine, no degradation of the underlying degradable metal alloy was initiated.

Some of these parts were then soaked in a hydrocarbon solvent for approximately one hour. Breach of the fast-acting trigger patch occurred within 1 hour of hydrocarbon solvent exposure. After the hydrocarbon solvent soak, the delamination of the patches was visually observed, exposing underlying surfaces of the degradable alloy. Then the degradation of a significant area of the degradable alloy parts was confirmed when the parts were soaked in warm, almost-saturated concentration brine at high pressure. Meanwhile, the other parts were continuously soaked in the same 1-10 wt % brine for several hours. The slower trigger was finally breached, and the degradable metal alloy began degrading when the entire soak time passed approximately 10 hours. These test examples show that both the slow trigger fuse and the fast-acting trigger patch each play a timer role independently when both are implemented together into a single degradable part with a coating.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A downhole tool, comprising:
a substrate including a degradable material;
a protective barrier configured to protect the degradable material from a downhole environment; and
a first trigger comprising a first trigger material that delaminates after contact with an organic solvent.

2. The downhole tool of claim 1, where the first trigger activates within about 1 minute to 60 minutes of contact with the organic solvent.

3. The downhole tool of claim 1, where the first trigger material exhibits a swelling percentage of at least 2.5% after contact with the prescribed organic solvent, where the swelling is by weight, volume, or both.

4. The downhole tool of claim 1, where the first trigger material is a polymer selected from the group consisting of polyurethanes, polysiloxanes, polyacrylates, polyepoxides, waxes, and combinations thereof.

5. The downhole tool of claim 1, where the organic solvent is selected from the group consisting of ketones, alcohols, ethers, hydrocarbons, and combinations thereof.

6. The downhole tool of claim 1, where the organic solvent is selected from the group consisting of acetone, methanol, ethanol, propanol, isopropanol, benzene, ethylbenzene, toluene, xylene, gasoline, diesel fuel, biodiesel fuel, kerosene, tetrahydrofuran, oil-based mud, and combinations thereof.

7. The downhole tool of claim 1, where the barrier comprises a conformal coating.

8. The downhole tool of claim 7, where the conformal coating is deposited on the substrate with chemical vapor deposition.

9. The downhole tool of claim 1, where the first trigger covers a breach in the protective barrier.

10. The downhole tool of claim 1, where activation of the first trigger exposes the substrate to one or more components of the downhole environment.

11. The downhole tool of claim 1, further comprising a second trigger.

12. The downhole tool of claim 11, where the second trigger is configured to activate within about 60 minutes to about 16 hours of contact with an aqueous fluid.

13. The downhole tool of claim 11, where the second trigger comprises a second trigger material which degrades on contact with the aqueous fluid.

14. The downhole tool of claim 13, where the second trigger material comprises a chemical element selected from the group consisting of magnesium, aluminum, calcium, germanium, zinc, manganese, and combinations thereof.

15. The downhole tool of claim 11, wherein the aqueous fluid is selected from the group consisting of a salt solution, an acidic solution, an alkali solution, and combinations thereof.

16. The downhole tool of claim 11, wherein a ratio Y/X is from about 2 to about 100,000, Y being a time of activation of the second trigger, X being a time of activation of the first trigger.

17. The downhole tool of claim 1, where the downhole tool is selected from the group consisting of a frack plug, frack ball, oilfield services element, oilfield element, collar, packer, sleeve, tubing, anchor, flow pipe, sensor, lock, actuator, cable, seal, projectile, liner, pump, motor, drilling equipment, mandrel, joint, centralizer, ball drop system, shroud, sand screen, casing, or sheet.

18. A method of treating a downhole formation comprising:
positioning a frack plug in a wellbore, the frack plug comprising:
a substrate including a degradable material,
a protective barrier configured to protect the degradable material from a downhole environment,
a first trigger comprising a first trigger material that delaminates after contact with an organic solvent, and
a second trigger configured to activate after contact with an aqueous fluid; and
exposing the plug to a wellbore fluid comprising an aqueous fluid.

19. The method of claim 18, where the aqueous fluid is brine.

20. The method of claim 18, further comprising exposing the plug to an organic solvent.

21. The method of claim 20, where the organic solvent is selected from the group consisting of ketones, alcohols, ethers, hydrocarbons, and combinations thereof.

22. The method of claim 20, where the organic solvent is selected from the group consisting of acetone, methanol, ethanol, propanol, isopropanol, benzene, ethylbenzene, toluene, xylene, gasoline, diesel fuel, biodiesel fuel, kerosene, tetrahydrofuran, oil-based mud, and combinations thereof.

23. The method of claim 20, further comprising exposing the plug to an aqueous fluid after exposing the plug to the organic solvent.

24. The method of claim 23, wherein the aqueous fluid is selected from the group consisting of a salt solution, an acidic solution, an alkali solution, and combinations thereof.

25. The method of claim 20, where the first trigger activates within about 60 seconds to about 60 minutes of contact with the organic solvent.

26. The method of claim 18, where the first trigger material exhibits a swelling percentage of at least 2.5% after contact with an organic solvent, where the swelling is by weight, volume, or both.

27. The method of claim 18, where the first trigger material is a polymer selected from the group consisting of polyurethanes, polysiloxanes, polyacrylates, polyepoxides, waxes, and combinations thereof.

28. The method of claim 18, wherein the substrate is substantially dissolved within about 1 hour to seven days of exposure to the aqueous fluid.

29. The method of claim 18, further comprising placing an explosive charge up-hole of the plug and setting off the explosive charge.

30. The method of claim 18, further comprising hydraulic fracking up-hole of the plug.

31. The method of claim 18, where the second trigger comprises a second trigger material which degrades on contact with an aqueous fluid.

32. The method of claim 31, where the second trigger material comprises a chemical element selected from the group consisting of magnesium, aluminum, calcium, germanium, zinc, manganese, and combinations thereof.

33. The method of claim 18, wherein a ratio Y/X is from about 2 to about 100,000, Y being a time of activation of the second trigger, X being a time of activation of the first trigger.

34. The method of claim 18, where the downhole formation contains at least one of natural gas and petroleum.

35. A downhole tool, comprising:
a substrate including a degradable material;
a protective barrier configured to protect the degradable material from a downhole environment; and
a first trigger comprising a polymer that, after exposure to a prescribed organic solvent for between about 1 minute and about 90 minutes, exposes the substrate to at least one component of the downhole environment.

36. The downhole tool of claim 35, where the first trigger activates within 30 minutes of contact with the organic solvent.

37. The downhole tool of claim 35, where the polymer exhibits a swelling percentage of at least 2.5% after contact with the organic solvent, where the swelling by weight, volume, or both.

38. The downhole tool of claim 35, where the polymer is selected from the group consisting of polyurethanes, polysiloxanes, polyacrylates, polyepoxides, waxes, and combinations thereof.

39. The downhole tool of claim 35, where the organic solvent is selected from the group consisting of ketones, alcohols, ethers, hydrocarbons, and combinations thereof.

40. The downhole tool of claim 35, where the organic solvent is selected from the group consisting of acetone, methanol, ethanol, propanol, isopropanol, benzene, ethylbenzene, toluene, xylene, gasoline, diesel fuel, biodiesel fuel, kerosene, tetrahydrofuran, oil-based mud, and combinations thereof.

41. The downhole tool of claim 35, where the downhole tool is selected from the group consisting of a frack plug, frack ball, oilfield services element, oilfield element, collar, packer, sleeve, tubing, anchor, flow pipe, sensor, lock, actuator, cable, seal, projectile, liner, pump, motor, drilling equipment, mandrel, joint, centralizer, ball drop system, shroud, sand screen, casing, or sheet.

42. The downhole tool of claim 35, where, after exposure to the organic solvent, the degradation of the substrate is activated within 30 minutes of exposure to brine.

43. The downhole tool of claim 35, further comprising a second trigger configured to activate after contact with an aqueous fluid.

44. A method of manufacturing a downhole tool, comprising:
applying a protective barrier to a substrate including a degradable material; and
installing a first trigger comprising a first trigger material that exhibits a swelling percentage of at least 2.5% after contact with a prescribed organic solvent, where the swelling is by weight, volume, or both.

45. The method of claim 44, where the barrier is applied with chemical vapor deposition.

46. The method of claim 44, further comprising installing a second trigger configured to activate within about 60 minutes to 16 hours of contact with an aqueous fluid.
